(19) United States
(12) Patent Application Publication
(10) Pub. No.: US 2016/0274972 A1
(43) Pub. Date: Sep. 22, 2016

(54) MDS ERASURE CODE CAPABLE OF REPAIRING MULTIPLE NODE FAILURES

(71) Applicant: PEKING UNIVERSITY SHENZHEN GRADUATE SCHOOL, Shenzhen (CN)

(72) Inventors: Hui LI, Shenzhen (CN); Hanxu HOU, Shenzhen (CN); Kenneth W. SHUN, Shenzhen (CN); Zhihao HUANG, Shenzhen (CN)

(21) Appl. No.: 15/164,833

(22) Filed: May 25, 2016

Related U.S. Application Data
(63) Continuation-in-part of application No. PCT/CN2015/071114, filed on Jan. 20, 2015.

(51) Int. Cl. G06F 11/10

(52) U.S. Cl. CPC G06F 11/1088; G06F 11/1096; G06F 2211/109

(57) ABSTRACT

An MDS erasure code capable of repairing multiple node failures, being a C(k, r, p) code which stores original information data blocks and parity data blocks by constructing a (p−l)*(k+r) matrix, in which, p is a prime larger than both k and r, k is an arbitrary integer between 2 and p, and r is smaller than or equal to 5. Both an addition operation and a subtraction operation of the C(k, r, p) code are substituted by an XOR operation. An original data block is split into k columns of the original information data blocks with each column containing p−l bits. r columns of the parity data blocks that are linearly independent from one another are generated from the k columns of the original information data blocks. After being changed, the original information data blocks and the parity data blocks are linearly independent.

### CROSS-REFERENCE TO RELATED APPLICATIONS

This application is a continuation-in-part of International Patent Application No. PCT/CN2015/071114 with an international filing date of Jan. 20, 2015, designating the United States, now pending, the contents of which, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND OF THE INVENTION

1. Field of the Invention

The invention relates to the field of the distributed storage system, and more particularly to a maximum distance separable (MDS) erasure code capable of repairing multiple node failures.

2. Description of the Related Art

A typical method for overcoming storage node failure in the distributed storage system is introducing a redundancy by (n, k) MDS erasure code, which splits a file into k original information blocks and generates n-k parity blocks from the k original information blocks so as to reconstruct the original file by gathering any k blocks from the n encoding blocks. However, the common MDS code has high encoding complexity and high updating complexity. In addition, the fault-tolerance thereof is low and at the most, two failure nodes can be recovered.

### SUMMARY OF THE INVENTION

In view of the above-described problems, it is one objective of the invention to provide an MDS erasure code capable of repairing multiple node failures. The MDS erasure code of the invention has high fault-tolerance.

To achieve the above objective, in accordance with one embodiment of the invention, there is provided an MDS erasure code capable of repairing multiple node failures. The MDS erasure code is a C(k, r, p) code which stores original information data blocks and parity data blocks by constructing a (p−l)* (k+r) matrix, in which, p is a prime larger than both k and r, k is an arbitrary integer between 2 and p, and r is smaller than or equal to 5. Both an addition operation and a subtraction operation of the C(k, r, p) code are substituted by an XOR operation. An original data block is split into k columns of the original information data blocks with each column containing p−l bits. r columns of the parity data blocks that are linearly independent from one another are generated from the k columns of the original information data blocks. The original information data blocks and the parity data blocks after being changed are linearly independent.

In a class of this embodiment, the MDS erasure code comprises a construction process comprising:

A) splitting original data B into k original information data blocks with each data block containing L=p−l bits;

B) constructing the parity data blocks; and

C) distributing a total n blocks of the original information data blocks and the parity data blocks to n nodes for storage.

In a class of this embodiment, in A), the original information data blocks are represented by SS=(SS₀,SS₁, . . . SSₖ₋₁), where SS ⱼ is denoted as s_{0,j}s_{1,j} . . . s_{p-2,j}, s_{p-1,j}=s_{0,j}+s_{1,j}+ . . . s_{p-2,j} is calculated to obtain S=(S₀, S₁, . . . Sₖ₋₁), where Sⱼ is denoted as s_{0,j}s_{1,j} . . . s_{p-1,j} and in which j=0,1, . . . k−1.

In a class of this embodiment, in B), the parity data blocks are represented by CC=(CC₀, CC₁, . . . CCᵣ₋₁), Cⱼ=S₀+x^{j}S₁+x^{j}S₁+x^{j=2}S₂+ . . . x^{j=(k-1)}Sₖ₋₁, c_{p-1,j}=c_{0,j}+c_{1,j}+ . . . c_{p-2,j}, in which j=0,1, . . . r−1, multiplication by x^{j=(k-1)} represents cyclically shifting to the left, and + represents the XOR operation.

In a class of this embodiment, in C), each node stores data, and the data stored in the nodes are represented by (SS₀, SS₁, . . . SSₖ₋₁, CC₀, CC₁, . . . CCᵣ₋₁).

In a class of this embodiment, the MDS erasure code further comprises a decoding process comprising: collecting l parity data blocks and k−l available original information data blocks when l originial information data blocks Sⱼ fail; substracting the k−l available original information data blocks from each of the l parity data blocks to obtain l linear equations; and calculating an inverse matrix of an encoding matrix corresponding to the l linear equations, and putting known data into the inverse matrix to finish decoding.

In a class of this embodiment, the decoding process is capable of recovering five node failures.

Advantages of the MDS erasure code according to embodiments of the invention are summarized as follows: the MDS erasure code of the invention largely improves the fault-tolerance capacity of the system, possesses low computational complexity and small computational overhead, and greatly reduces the computational delay of the system, thus, saving time and resource, decreasing the cost, and being suitable for the actual storage system.

### BRIEF DESCRIPTION OF THE DRAWINGS

The invention is described hereinbelow with reference to accompanying drawings, in which the sole figure is a flow diagram of a construction process of an MDS code capable of repairing multiple node failures in accordance with one embodiment of the invention.

### DETAILED DESCRIPTION OF THE EMBODIMENTS

For further illustrating the invention, experiments detailing an MDS erasure code capable of repairing multiple node failures are described below. It should be noted that the following examples are intended to describe and not to limit the invention.

Related terms are defined as follows:

MDS: Maximum Distance Separable

RDP: Row-Diagonal Parity

An MDS erasure code capable of repairing multiple node failures is provided. The MDS erasure code is a C(k, r, p) code which stores original information data blocks and parity data blocks by constructing a (p−l)*(k+r) matrix, in which, p is a prime larger than both k and r, k is an arbitrary integer between 2 and p, and r is smaller than or equal to 5. Both an addition operation and a subtraction operation of the C(k, r, p) code are substituted by an XOR operation. An original data block is split into k columns of the original information data blocks with each column containing p−l bits. r columns of the parity data blocks that are linearly independent from one another are generated from the k columns of the original information data blocks. The original information data blocks and the parity data blocks after being changed are linearly independent.

The MDS erasure code of the invention comprises a construction process comprising: A) splitting original data B into k original information data blocks with each data block containing L=p−l bits; B) constructing the parity data blocks; and C) distributing a total n blocks of the original information data blocks and the parity data blocks to n nodes for storage.

In A), the original information data blocks are represented by SS=(SS₀, SS₁, . . . SSₖ₋₁), s_{p-1,j}=s_{0,j}+s_{1,j}+ , . . . s_{p-2,j} is calculated to obtain S=(S₀, S₁, . . . Sₖ₋₁), in which j=0,1, . . . k−1.

In B), the parity data blocks are represented by CC=(CC₀, CC₁, . . . CCᵣ₋₁), Cⱼ=S₀+x^{j}S₁+x^{j=2}S₂+ . . . x^{j=(k-1)}Sₖ₋₁, c_{p-1,j}=c_{0,j}+c_{1,j}+ . . . c_{p-2,j}, in which j=0,1, . . . r−1, multiplication by x^{j=(k-1)} represents cyclically shifting to the left, and + represents the XOR operation.

In C), each node stores data, and the data stored in the nodes are represented by (SS₀, SS₁, . . . SSₖ₋₁, CC₀, CC₁, . . . CCᵣ₋₁).

The MDS erasure code of the invention further comprises a decoding process comprising: collecting l parity data blocks and k−l available original information data blocks when l originial information data blocks Sⱼ fail; substracting the k−l available original information data blocks from each of the l parity data blocks to obtain l linear equations; and calculating an inverse matrix of an encoding matrix corresponding to the l linear equations, and putting known data into the inverse matrix to finish decoding.

The decoding process is capable of recovering five node failures.

In one embodiment, the MDS code is the C(k, r, p) code, all addition and subtraction operations in the context can be substituted by the XOR operation. The C(k, r, p) code is used to store original information data blocks and parity data blocks by constructing the (p−1)×(k+r) matrix, in which, p is a primer larger than k and r, k is an arbitrary integer between 2 and p, and r is smaller or equal to 5.

The original data block is split into k columns of the original information data blocks with each column containing p−l bits. Let s_{i,j} denote an i-th bit in a j-th column of original information data block, in which, i=0,1, . . . p−2. To facilitate the calculation of the parity data blocks, let s_{p-1,j}=s_{0,j}+s_{1,j}+ . . . s_{p-2,j}, SSⱼ is denoted as s_{0,j}s_{1,j} . . . s_{p-2,j}, Sⱼ is denoted as s_{0,j}s_{1,j} . . . s_{p-1,j}, in which, j=0,1, . . . k−1.

r columns of linearly independent parity data blocks are generated according to k columns of the original information data blocks. Let c_{i,j} denote the i-th bit in the j-th column of parity data block, i=0,1, . . . p−2, let c_{p-1,j}=c_{0,j}+c_{1,j}+ . . . c_{p-2,j}, CCⱼ is denoted as c_{0,j}c_{1,j} . . . c_{p-2,j}, Cⱼ is denoted as c_{0,j}C_{1,j} . . . c_{p-1,j}, j=0,1, . . . r−1. To enable the original information data blocks to be linearly independent from the parity data blocks after data change, the j-th column of parity data block can be derived from the following equation:

Cⱼ=S₀+x^{j}S₁+x^{j=2}S₂+ . . . x^{j=(k-1)}Sₖ₋₁, in which multiplication by x^{j=(k-1)} denotes cyclically shifting by (k−l)j bits, and herein the cyclically shifting is defined as cyclically shifting to the left. After Cⱼ is obtained, let c_{p=1,j}=c_{0,j}+c_{1,j}+ . . . c_{p-2,j}. Actually, a primary method to calculate the parity data blocks is to multiply the original information data block by a Vandermonde matrix, which is specifically as follows:

$$[ \begin{matrix}{C}_{0} \\ {C}_{1} \\ ⋮ \\ {C}_{r - 1}\end{matrix} ] = [ \begin{matrix}1 & 1 & 1 & … & 1 \\ 1 & x & {x}^{2} & … & {x}^{k - 1} \\ 1 & ⋮ & ⋮ & ⋱ & ⋮ \\ 1 & {x}^{r - 1} & {x}^{2 * ( r - 1 )} & … & {x}^{( k - 1 ) * ( r - 1 )}\end{matrix} ] [ \begin{matrix}{S}_{0} \\ {S}_{1} \\ ⋮ \\ {S}_{k - 1}\end{matrix} ]$$

The parity data blocks constructed by this method satisfy the linearly independence from one another, and only the XOR operation and the cyclically shifting are adopted.

Construction process of the C(k, r, p) code:

The C(k, r, p) code is applied in a system containing n nodes and each node stores one original information data block or parity data block. A file is split into k original information data blocks of equal size and stored in k nodes. The k nodes are called systematic nodes. In addition, the encoded r parity data blocks are stored in the remaining r nodes, and these nodes are called parity nodes. And n=k+r.

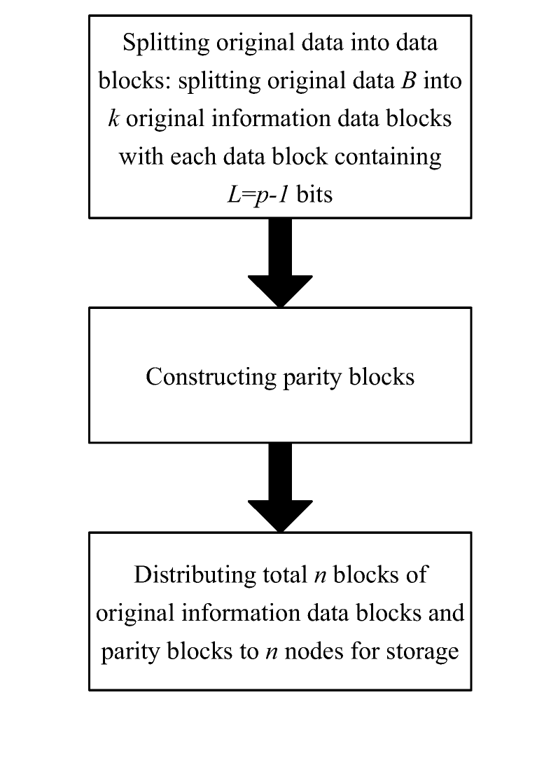

Constructing process of the C(k, r, p) code is illustrated as FIG. 1:

1) The original data B is split into k data blocks with each data block containing L=p−1 bits of data. The original information data are denoted as SS=(SS₀, SS₁, . . . SSₖ₋₁), s_{p-1,j}=s_{0,j}+s_{1,j}+ . . . s_{p=2,j} is calculated to obtain S=(S₀, S₁, . . . Sₖ₋₁), in which, j=0,1, . . . k−1.

2) Construction of the parity data blocks:

CC =(CC₀, CC₁, . . . CCᵣ₋₁), Cⱼ=S₀+x^{j}S₁+x^{j=2}S₂+ . . . x^{j=(k-1)}Sₖ₋₁, C_{p-1,j}=c_{0,j}+c_{1,j}+ . . . c_{p-2,j}, in which j=0,1, . . . r−1, multiplication by x^{j=(k-1)} denotes the cyclically shifting to the left, and +represents the XOR operation.

3) data are distributed to each node for storage, and the data stored at the nodes are (SS₀, SS₁, . . . SSₖ₋₁, CC₀, CC₁, . . . CCᵣ₋₁).

That is, s_{p-1,j} and c_{p-1,j} appeared in the above context are not stored, and the appearances thereof are only for computation convenience.

For example, given that k=4, r=3, and p=5, and a C(4,3,5) code is constructed. The original information data blocks are SS₀, SS₁, SS₂, and SS₃, respectively, and the parity data blocks are CC₀, CC₁, and CC₂, respectively, and this code is able to recover at most three node failures.

The computational process of the parity data blocks are as follows:

First, s_{p-1,j} is calculated based on SSⱼ.

| S₀ | S₁ | S₂ | S₃ | C₀ | C₁ | C₂ |
|---|---|---|---|---|---|---|
| s_{0,0} | s_{0,1} | s_{0,2} | s_{0,3} | | | |
| s_{1,0} | s_{1,1} | s_{1,2} | s_{1,3} | | | |
| s_{2,0} | s_{2,1} | s_{2,2} | s_{2,3} | | | |
| s_{3,0} | s_{3,1} | s_{3,2} | s_{3,3} | | | |
| s_{4,0} | s_{4,1} | s_{4,2} | s_{4,3} | | | |

A first parity data block is constructed according to C₀=S₀+S₁+S₂+ . . . Sₖ₋₁.

| S₀ | S₁ | S₂ | S₃ | C₀ | C₁ | C₂ |
|---|---|---|---|---|---|---|
| s_{0,0} | s_{0,1} | s_{0,2} | s_{0,3} | c_{0,0} | | |
| s_{1,0} | s_{1,1} | s_{1,2} | s_{1,3} | c_{1,0} | | |
| s_{2,0} | s_{2,1} | s_{2,2} | s_{2,3} | c_{2,0} | | |
| s_{3,0} | s_{3,1} | s_{3,2} | s_{3,3} | c_{3,0} | | |
| s_{4,0} | s_{4,1} | s_{4,2} | s_{4,3} | | | |

A second parity data block is constructed according to C₁=S₀+xS₁+x S₂+ . . . x^{k-1}Sₖ₋₁.

| S₀ | S₁ | S₂ | S₃ | C₀ | C₁ | C₂ |
|---|---|---|---|---|---|---|
| s_{0,0} | s_{1,1} | s_{2,2} | s_{3,3} | | c_{0,1} | |
| s_{1,0} | s_{2,1} | s_{3,2} | s_{4,3} | | c_{1,1} | |
| s_{2,0} | s_{3,1} | s_{4,2} | s_{0,3} | | c_{2,1} | |
| s_{3,0} | s_{4,1} | s_{0,2} | s_{1,3} | | c_{3,1} | |
| s_{4,0} | s_{0,1} | s_{1,2} | s_{2,3} | | | |

A third parity data block is constructed according to C₂=S₀+x²S₁+x⁴S₂+ . . . x⁶Sₖ₋₁.

| S₀ | S₁ | S₂ | S₃ | C₀ | C₁ | C₂ |
|---|---|---|---|---|---|---|
| s_{0,0} | s_{2,1} | s_{4,2} | s_{1,3} | | | c_{0,2} |
| s_{1,0} | s_{3,1} | s_{0,2} | s_{2,3} | | | c_{1,2} |
| s_{2,0} | s_{4,1} | s_{1,2} | s_{3,3} | | | c_{2,2} |
| s_{3,0} | s_{0,1} | s_{2,2} | s_{4,3} | | | c_{3,2} |
| s_{4,0} | s_{1,1} | s_{3,2} | s_{0,3} | | | |

Finally, c_{p-1,j} is calculated based on CCⱼ.

| S₀ | S₁ | S₂ | S₃ | C₀ | C₁ | C₂ |
|---|---|---|---|---|---|---|
| s_{0,0} | s_{0,1} | s_{0,2} | s_{0,3} | c_{0,0} | c_{0,1} | c_{0,2} |
| s_{1,0} | s_{1,1} | s_{1,2} | s_{1,3} | c_{1,0} | c_{1,1} | c_{1,2} |
| s_{2,0} | s_{2,1} | s_{2,2} | s_{2,3} | c_{2,0} | c_{2,1} | c_{2,2} |
| s_{3,0} | s_{3,1} | s_{3,2} | s_{3,3} | c_{3,0} | c_{3,1} | c_{3,2} |
| s_{4,0} | s_{4,1} | s_{4,2} | s_{4,3} | c_{4,0} | c_{4,1} | c_{4,2} |

For another example, SS₀=1111, SS₁=0111, SS₂=1001, and SS₃=0101.

First, s_{p-1,j} is calculated based on SSⱼ.

| S₀ | S₁ | S₂ | S₃ | C₀ | C₁ | C₂ |
|---|---|---|---|---|---|---|
| 1 | 0 | 1 | 0 | | | |
| 1 | 1 | 0 | 1 | | | |
| 1 | 1 | 0 | 0 | | | |
| 1 | 1 | 1 | 1 | | | |
| 0 | 1 | 0 | 0 | | | |

A first parity data block is constructed according to C₀=S₀+S₁+S₂+ . . . S₋₁.

| S₀ | S₁ | S₂ | S₃ | C₀ | C₁ | C₂ |
|---|---|---|---|---|---|---|
| 1 | 0 | 1 | 0 | 0 | | |
| 1 | 1 | 0 | 1 | 1 | | |
| 1 | 1 | 0 | 0 | 0 | | |
| 1 | 1 | 1 | 1 | 0 | | |
| 0 | 1 | 0 | 0 | | | |

A second parity data block is constructed according to C₁=S₀+xS₁+x²S₂+ . . . x^{k-1}Sₖ₋₁.

| S₀ | S₁ | S₂ | S₃ | C₀ | C₁ | C₂ |
|---|---|---|---|---|---|---|
| 1 | 1 | 0 | 1 | | 1 | |
| 1 | 1 | 1 | 0 | | 1 | |
| 1 | 1 | 0 | 0 | | 0 | |
| 1 | 1 | 1 | 1 | | 0 | |
| 0 | 0 | 0 | 0 | | | |

A third parity data block is constructed according to C₂=S₀+x²S₁x⁴S₂+ . . . x⁶Sₖ₋₁.

| S₀ | S₁ | S₂ | S₃ | C₀ | C₁ | C₂ |
|---|---|---|---|---|---|---|
| 1 | 1 | 0 | 1 | | | 1 |
| 1 | 1 | 1 | 0 | | | 1 |
| 1 | 1 | 0 | 1 | | | 1 |
| 1 | 0 | 0 | 0 | | | 1 |
| 0 | 1 | 1 | 0 | | | |

Finally, c_{p-1,j} is calculated based on CCⱼ.

| S₀ | S₁ | S₂ | S₃ | C₀ | C₁ | C₂ |
|---|---|---|---|---|---|---|
| 1 | 0 | 1 | 0 | 0 | 1 | 1 |
| 1 | 1 | 0 | 1 | 1 | 1 | 1 |
| 1 | 1 | 0 | 0 | 0 | 0 | 1 |
| 1 | 1 | 1 | 1 | 0 | 0 | 1 |
| 0 | 1 | 0 | 0 | 1 | 0 | 0 |

Reconstruction process of the C(k, r, p) code is as follows:

The C(k, r, p) code only adopts the simple XOR operation, and it only requires gathering any k data blocks during data reconstruction. When the original information data blocks are damaged, the parity data blocks are utilized to perform the decoding calculation.

The basic idea of the decoding process of the C(k, r, p) code is introduced herein. Because each parity data block Cⱼ is a result of a linear combination of cyclically shifting of all Sⱼ. Given that l original information data blocks Sⱼ fail, l parity data blocks and k−l available original information data blocks are gathered, and all the k−l available original information data blocks are subtracted from each of the l parity data blocks to obtain l linear equations. The inverse matrix of the encoding matrix corresponding to the l linear equations is computed and then known data are put into the inverse matrix to accomplish the decoding.

The decoding process of the C(4, 3, 5) code is as follows:

Given that S₀, S₃, C₀, C₁, and C₂ are available while S₁ and S₂ fail, then S₀, S₃, C₀, and C₁ are adopted to repair the failure nodes.

Let f₀=C₀−S₀−S₃=S₁+S₂ and f₁=C₀−S₀−x³S₃=xS₁+x²S₂. Because f₀=C₀−S₀−S₃ and f₁=C₀−S₀−x³S₃, f₀ and f₁ are known.

That is, S₁ and S₂ can be denoted as follows:

$$[ \begin{matrix}{f}_{0} \\ {f}_{1}\end{matrix} ] = [ \begin{matrix}1 & 1 \\ x & {x}^{2}\end{matrix} ] [ \begin{matrix}{S}_{1} \\ {S}_{2}\end{matrix} ] , i . e . , \\ [ \begin{matrix}{S}_{1} \\ {S}_{2}\end{matrix} ] = {[ \begin{matrix}1 & 1 \\ x & {x}^{2}\end{matrix} ]}^{- 1} [ \begin{matrix}{f}_{0} \\ {f}_{1}\end{matrix} ] .$$

Since f₀ and f₁ are known, it only requires to calculate an inverse of

$$[ \begin{matrix}1 & 1 \\ x & {x}^{2}\end{matrix} ] ,$$

and

$${[ \begin{matrix}1 & 1 \\ x & {x}^{2}\end{matrix} ]}^{- 1}$$

is calculated as follows:

$$[ \begin{matrix}1 & 1 \\ x & {x}^{2}\end{matrix} \vert \begin{matrix}1 & 0 \\ 0 & 1\end{matrix} ] mod ( 1 + x + {x}^{2} + {x}^{3} + {x}^{4} ) = [ \begin{matrix}1 & 1 \\ 0 & {x}^{2} + x\end{matrix} \vert \begin{matrix}1 & 0 \\ x & 1\end{matrix} ] = [ \begin{matrix}1 & 1 \\ 0 & 1\end{matrix} \vert \begin{matrix}1 & 0 \\ {x}^{3} + x & {x}^{2} + 1\end{matrix} ] = [ \begin{matrix}1 & 0 \\ 0 & 1\end{matrix} \vert \begin{matrix}{x}^{3} + x + 1 & {x}^{2} + 1 \\ {x}^{3} + x & {x}^{2} + 1\end{matrix} ] , \\ {[ \begin{matrix}1 & 1 \\ x & {x}^{2}\end{matrix} ]}^{- 1} = [ \begin{matrix}{x}^{3} + x + 1 & {x}^{2} + 1 \\ {x}^{3} + x & {x}^{2} + 1\end{matrix} ] .$$

Thus, S₁=(x³+x+1) f₀+(x²+1) f₁ and S₂=(x³+X) f₀+(x²+1) f₁.

The decoding results are S₁=01111 and S₂=10010, thus the decoding is correct.

In the above, the circumstance of repairing two node failures are described, and this codec method can also be applied to at most five node failures.

Performance evaluation of the C(k, r, p) code

Encoding complexity:

Because different codes have different requirements on the number of the original information data blocks and the bit number of each data block, to make the comparison convenient, the average encoding complexities at each bit are compared among different coding modes. The EVENODD code has two parity data blocks, and each parity bit in the two parity columns is the XOR operation result of information passing through straights lines with a slope of 0 or 1. The average encoding complexity of each bit of the EVENODD node is

$$1 - \frac{1}{2 ( p - 1 )} .$$

The RDP code has two parity data blocks, the first parity data block is obtained by the XOR operation of k original data blocks, as each data block has a length of L bits, (k−l)L XOR operations are performed. While the second parity data block is obtained by the XOR operation of k data blocks in pandiagonal, and similarly (k−l)L XOR operations are performed. BBV code is a code capable of repairing multiple node failures, and the average encoding complexity of each bit thereof is

$$2 - \frac{1}{r} - \frac{2 ( r - 1 )}{rp} .$$

For C(k, r, p) code, the system has (n-k) parity data blocks and each parity data block is obtained by the XOR operation of k original data blocks. Thus, the encoding of each parity data block requires (k−l)L XOR operations, and the average encoding complexity of each bit of the C(k, r, p) code is

$$\frac{rk - 1}{rk} .$$

Decoding Complexity:

Because different codes have different requirements on the number of the original data blocks and the bit number of each data block, to make the comparison convenient, the average encoding complexities at each bit are compared among different coding modes. Since the common MDS codes can only repair two node failures, herein the recovery of two node failures is discussed.

The RDP code is decoded by iteration and not related to the calculation of finite field itself. The average decoding complexity at each bit of the RDP code is

$$\frac{2 ( p - 1 )}{p - 1} .$$

The average decoding complexity at each bit of the EVENODD code is larger than

$$\frac{2 ( p - 1 )}{p - 1} .$$

The average decoding complexity at each bit of the C(k, r, p) code is

$$\frac{2 {p}^{2} - 3.5 p - 1.5}{{( p - 1 )}^{2}} .$$

Thus, the general encoding complexity of the C(k, r, p) code is equivalent to those of the EVENODD code and the RDP code and approaches 1, while the general encoding complexity of the BBV code that is capable of recovering at most two node failures approaches 2. Thus, the encoding complexity of the C(k, r, p) code is relatively optimal.

For the decoding, the general decoding complexity of the C(k, r, p) code is equivalent to that of the RDP code, that is, the C(k, r, p) code is relatively optimal.

Comparison of encoding and decoding complexities among different codes

| | EVENODD | RDP | BBV | C(k, r, p) |
|---|---|---|---|---|
| Encoding complexity | $1 - \frac{1}{2 ( p - 1 )}$ | $1 - \frac{1}{p - 1}$ | $2 - \frac{1}{r}$ | $\frac{rk - 1}{rk}$ |
| | | | $- \frac{2 ( r - 1 )}{rp}$ | |
| Decoding complexity | $> \frac{2 ( p - 1 )}{p - 1}$ | $\frac{2 ( p - 1 )}{p - 1}$ | — | $\frac{2 {p}^{2} - 3.5 p - 1.5}{{( p - 1 )}^{2}}$ |

p is a prime and k represents a number of the systematic nodes;
r represents a number of damaged original information data blocks in decoding; and Values in the table represent numbers of bits requiring XOR operation.

Compared with the common MDS codes, the C(k, r, p) code features its capability of recovering at most five node failures. The simple and operable XOR operation is adopted, so that both the encoding complexity and the decoding complexity are relatively low. Furthermore, the number of the original information data blocks are not fixed and can be arbitrary integer between 2 and p. Compared with the EVENODD code and the RDP code that are only able to recover two failure nodes, the C(k, r, p) code improves the fault-tolerance of the system and is able to repair at most five node failures with hardly changing the encoding complexity and the decoding complexity. Compared with the BBV code that is able to recover more than two failure nodes, the C(k, r, p) code has much lower encoding complexity and decoding complexity under the same condition of recovering the multiple failure nodes.

The C(k, r, p) code possesses optimized encoding and decoding complexities, the fault-tolerance of the system is greatly improved. Besides, the number of the original information data blocks is not fixed and can be arbitrary integer between 2 and p, thus the C(k, r, p) code is much flexible and realizes optimized compromise between the storage overhead and the system reliability.

Unless otherwise indicated, the numerical ranges involved in the invention include the end values. While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A maximum distance separable (MDS) erasure code capable of repairing multiple node failures, the erasure code being a C(k, r, p) code which stores original information data blocks and parity data blocks by constructing a (p−l)*(k+r) matrix, in which, p is a prime larger than both k and r, k is an arbitrary integer between 2 and p, and r is smaller than or equal to 5;
wherein
both an addition operation and a subtraction operation of the C(k, r, p) code are substituted by an XOR operation;
an original data block is split into k columns of the original information data blocks with each column containing p−l bits;
r columns of the parity data blocks that are linearly independent from one another are generated from the k columns of the original information data blocks; and
after being split, the original information data blocks and the parity data blocks are linearly independent.

2. The code of claim 1, comprising a construction process comprising:
A) splitting original data B into k original information data blocks with each data block containing L=p−l bits;
B) constructing the parity data blocks; and
C) distributing a total n blocks of the original information data blocks and the parity data blocks to n nodes for storage.

3. The code of claim 2, wherein in A), the original information data blocks are represented by SS=(SS₀,SS₁,SSₖ₋₁), s_{p-1,j}=s_{0,j}+s_{1,j}+ . . . s_{p-2,j} is calculated to obtain S=(S₀, S₁, . . . Sₖ₋₁), in which j=0,1, . . . k−1.

4. The code of claim 2, wherein in B), the parity data blocks are represented by CC=(CC₀, CC₁, . . . CCᵣ₋₁), Cⱼ=S₀+x^{j}S₁+x^{j=2}S₂+ . . . x^{j=(k-1)}Sₖ₋₁, c_{p-1,j}=c_{0,j}+c_{1,j}+ . . . c_{p-2,j}, in which j=0,1, . . . r−1, multiplication by x^{j=(k-1)} represents cyclically shifting to the left, and + represents the XOR operation.

5. The code of claim 2, wherein in C), each node stores data, and the data stored in the nodes are represented by (SS₀,SS₁, . . . SSₖ₋₁, CC₀,CC₁, . . . CCᵣ₋₁).

6. The code of claim 1, further comprising a decoding process comprising: collecting l parity data blocks and k−l available original information data blocks when l originial information data blocks Sⱼ fail; substracting the k−l available original information data blocks from each of the l parity data blocks to obtain l linear equations; and calculating an inverse matrix of an encoding matrix corresponding to the l linear equations, and putting known data into the inverse matrix to finish decoding.

7. The code of claim 6, wherein the decoding process is capable of recovering five node failures.
